(19) United States
(12) Patent Application Publication
(10) Pub. No.: US 2010/0038318 A1
(43) Pub. Date: Feb. 18, 2010

(54) ENHANCED SOLIDS CONTROL

(75) Inventors: Alan Gilmour, Houston, TX (US); Nicolas Christopher Wade Thiessen, Calgary (CA)

Correspondence Address: LEGAL DEPT., IP GROUP;M-I L.L.C., 5950 NORTH COURSE DRIVE, HOUSTON, TX, 77072, US

(73) Assignees: M-I L.L.C., Houston, TX (US); M-I DRILLING FLUIDS CANADA, INC., Calgary (CA)

(21) Appl. No.: 12/538,373

(22) Filed: Aug. 10, 2009

Related U.S. Application Data
(60) Provisional application No. 61/088,298, filed on Aug. 12, 2008.

(51) Int. Cl. E21B 21/06; F17D 1/00; F16K 11/00; C02F 1/52; C02F 1/56; B01D 21/30; B01D 21/26

(52) U.S. Cl. 210/709; 137/9; 137/605; 210/702; 210/724; 210/712; 210/143; 210/134

(57) ABSTRACT

A method of cleaning drilling fluid including providing a flow of drilling fluid to a treatment loop, determining a flow rate of the drilling fluid, and injecting a polymer into the drilling fluid based on the determined flow rate of the drilling fluid. Additionally, the method includes injecting a coagulant into the drilling fluid based on the determined flow rate of the drilling fluid and adjusting the rate of polymer and coagulant injection based on a change in the flow rate of the drilling fluid. Also, a method of controlling a drilling fluid cleaning system, the method including inputting a polymer dosage rate and a coagulant dosage rate into a system controller and providing instructions to the system controller. The instructions include determining an instantaneous flow rate of a drilling fluid in the system, calculating a polymer injection rate to produce the inputted polymer dosage rate based on the instantaneous flow rate of the drilling fluid, calculating a coagulant injection rate to produce the inputted coagulant dosage rate based on the instantaneous flow rate of the drilling fluid, and adjusting the polymer injection rate and the coagulant injection rate based on the instantaneous flow rate.

### CROSS-REFERENCE TO RELATED APPLICATION(S)

This application, pursuant to 35 U.S.C. §119(e), claims priority to U.S. Provisional Application Ser. No. 61/088,298, filed Aug. 12, 2008. That application is incorporated by reference in its entirety.

### BACKGROUND

1. Field of the Disclosure

The present disclosure generally relates to dewatering systems used in the management of drilling fluid waste and drilling fluid volume reduction. More particularly, the present disclosure relates to dewatering systems incorporating dry and/or liquid flocculant sources. More particularly still, the present disclosure relates to automated and self-contained dry and/or liquid dewatering systems.

2. Background Art

Generally, waste management dewatering systems separate solids and fine particles from the liquid phase of drilling fluid, thereby leaving a clarified aqueous solution. In a drilling operation, dewatering allows the cleaning of waste fluids, such as, drilling fluids mixed with water from the rotary table, mud tanks, mud pumps, generators and from any other discharge point around a drilling rig. Typically, dewatering waste management systems clean drilling fluid through coagulation, flocculation, and/or mechanical separation.

Coagulation occurs when the electrostatic charge on a solid is reduced, destabilizing the solid and allowing it to be attracted to other solids by van der Waals forces. Flocculation is the binding of individual solid particles into aggregates of multiple particles. Flocculation is physical, rather than electrical, and occurs when one segment of a flocculating polymer chain absorbs simultaneously onto more than one particle. Mechanical separation includes mechanical devices (e.g., hydrocyclones and centrifuges) that remove solid particles from a solution.

Traditionally, methods for removing solids from solutions in the dewatering of drilling fluid included the replication of natural mud flocculation mechanisms using either calcium or chlorine based ion contamination. Lime and various inorganic metal salt sources (e.g., AlCl₃) were used for flocculation. The solid aggregates could then be separated out by gravity filtration and/or a mechanical device, as described above.

However, with the introduction of non-dispersed, inhibitive water-based drilling fluids (e.g., partially-hydrolyzed polyacrylamide and KCl), the clay particles within a mud system are conditioned to resist ion contamination (i.e., resistant to flocculation and/or aggregation). Thus, the dewatering of such water-based drilling fluids require multi-charge, high molecular weight polymers for flocculation.

Typically, polymers used for flocculation are manufactured in dry form and mixed by dewatering system operators into a solution prior to treating a mud system. Also, because the dry polymer is added to a liquid, an aging process is required to activate the dry polymers. Additionally, these polymers tend to be hygroscopic, and as such, have a limited shelf life. Thus, when housed in outdoor storage facilities, such as typically occurs in current commercial drilling operations, the hygroscopic polymers take on water, thereby decreasing their effective life. Also, the polymers in current commercial systems are typically exposed to wide temperature variations, further resulting in decreased effective life. Due to the need of polymer solution aging, batch mixing, and the limited shelf life in Current commercial systems, management of dry flocculant dewatering systems is costly and resource dependent.

In response to the increased use of water-based drilling fluids, many companies now manufacture invert emulsion liquid flocculants and coagulants that provide increased activity and shelf life. However, due to their nanoemulsion formulation, these products require high energy for emulsion breaking and activation. Also, the liquid flocculants and coagulants still experience decreased shelf life when exposed to moisture and wide temperature variation. Thus, the liquid flocculants and coagulants do not always work effectively in current commercial systems.

Accordingly, there exists a need for a self-contained and automated dewatering system.

### SUMMARY OF THE DISCLOSURE

In one aspect, embodiments disclosed herein relate to methods of cleaning drilling fluid including providing a flow of drilling fluid to a treatment loop, determining a flow rate of the drilling fluid, and injecting a polymer into the drilling fluid based on the determined flow rate of the drilling fluid. Additionally, the method includes injecting a coagulant into the drilling fluid based on the determined flow rate of the drilling fluid and adjusting the rate of polymer and coagulant injection based on a change in the flow rate of the drilling fluid.

In another aspect, embodiments disclosed herein relate to a method of controlling a drilling fluid cleaning system, the method including inputting a polymer dosage rate and a coagulant dosage rate into a system controller and providing instructions to the system controller. The instructions include determining an instantaneous flow rate of a drilling fluid in the system, calculating a polymer injection rate to produce the inputted polymer dosage rate based on the instantaneous flow rate of the drilling fluid, calculating a coagulant injection rate to produce the inputted coagulant dosage rate based on the instantaneous flow rate of the drilling fluid, and adjusting the polymer injection rate and the coagulant injection rate based on the instantaneous flow rate.

In another aspect, embodiments disclosed herein relate to a system for processing drilling fluid, the system including an acid sub-system configured to modify a pH of the drilling fluid, a coagulant sub-system configured to inject a coagulant to the drilling fluid, a polymer sub-system configured to inject a polymer to the drilling fluid, and a system controller configured to automatically adjust the coagulant and polymer injection into the drilling fluid.

Other aspects and advantages of the invention will be apparent from the following description and the appended claims.

### BRIEF DESCRIPTION OF DRAWINGS

FIG. 1 is a schematic representation of a dry flocculant dewatering system in accordance with an embodiment of the present disclosure.

FIG. 2 is a process flow diagram of a dry flocculant dewatering system in accordance with an embodiment of the present disclosure.

FIG. 3 is a schematic illustration of a dry flocculant and coagulant dewatering system in accordance with an embodiment of the present disclosure.

FIG. 4 is a schematic illustration of a liquid flocculant dewatering system in accordance with an embodiment of the present disclosure.

FIG. 5 is a schematic illustration of a dry flocculant and liquid flocculant dewatering system in accordance with an embodiment of the present disclosure.

FIG. 6 is a schematic representation of a dewatering system in accordance with an embodiment of the present disclosure.

FIGS. 7A and 7B are flow charts of an automation cycle and manual override cycle in accordance with an embodiment of the present disclosure.

FIG. 8 is a main page graphical user interface showing an overview of the dewatering system in accordance with an embodiment of the present disclosure.

FIG. 9 is a startup screen of a graphical user interface showing startup profiles for a dewatering system in accordance with an embodiment of the present disclosure.

FIG. 10 is an automated control profiles screen of a graphical user interface showing startup profile for a dewatering system in accordance with an embodiment of the present disclosure.

FIG. 11 is a calculation screen of a graphical user interface showing calculations for a dewatering system in accordance with an embodiment of the present disclosure.

### DETAILED DESCRIPTION

In one aspect, embodiments disclosed herein relate to dewatering systems used in the management of drilling fluid waste and drilling fluid volume reduction. More particularly, the present disclosure relates to dewatering systems incorporating dry and/or liquid flocculant sources. More particularly still, the present disclosure relates to automated and self-contained dry and/or liquid dewatering systems.

Typically, as used drilling fluids return to the surface from down hole, drilled solids and other fine particulate matter may be suspended therein. Initially, the used drilling fluid may undergo any number of separation techniques (e.g., centrifugation, screening, mud cleaners, and shaking) to remove drilled solids from the fluid. While the aforementioned methods may remove large drilled solids, other solids and fine particulate matter may remain suspended in the drilling fluid. To further remove particulate matter, as described above, coagulation and/or flocculation may be used. One method for removing such fine solids and particulate matter is through the use of dewatering systems, such as those disclosed in U.S. patent application Ser. No. 11/461,969, Aug. 2, 2006, to M-I LLC, which is hereby incorporated by reference in its entirety.

Dewatering systems and the methods of controlling such systems disclosed herein may allow for a self-contained and automated system capable of processing wastewater from one or more wells at a drilling location. By automating such dewatering systems, the processing of wastewater may be adjusted according to changing drilling conditions, such as changes in formation type and fluid flow rates. Those of ordinary skill in the art will appreciate that the methods and logic systems disclosed herein may be used to automate the treatment of oil-based and/or water-based fluids at drilling locations; however, the processing of water-based fluids will be discussed in detail below. Before discussing the automation of individual components of the system in detail, exemplary components that may be used in the system will be discussed.

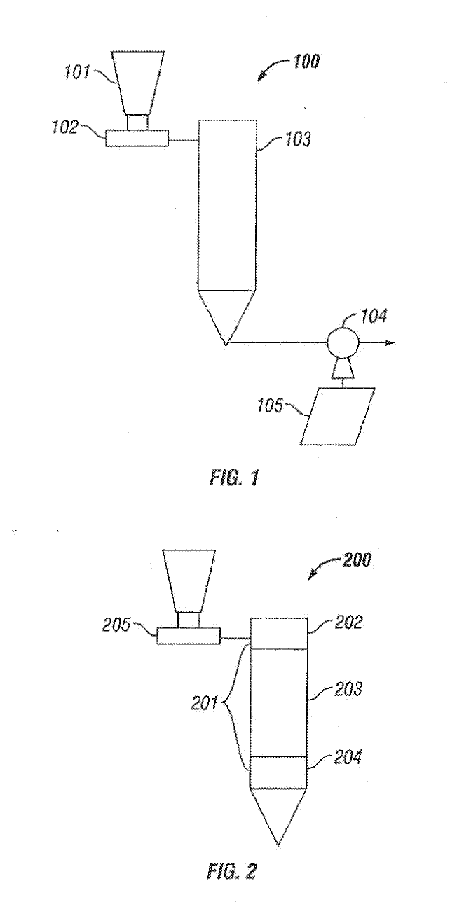

Referring initially to FIG. 1, a modular dewatering system 100 in accordance with an embodiment of the present disclosure, is shown. In this embodiment, a feeder 101 is connected to a polyductor 102. Feeder 101 may include any device (e.g., a hopper with a screen and a rotating disc) capable of holding and dispensing a dry flocculation powder. Polyductor 102 may include a high efficiency eductor designed specifically for dry polymers. Generally, polyductor 102 may generate a high vacuum airflow to transport dry polymer flocculant from the rotating disc of feeder 101. In such a system, polyductor 102 may be connected to feeder 101 and may receive dry flocculant polymer therefrom. Polyductor 102 may also be fluidly connected to a water supply line.

In one embodiment, polyductor 102 may dilute the dry flocculant using water accelerated in a high efficiency nozzle. The high velocity water flow may generate a vacuum by entraining air as it exits the nozzle. The high speed collision in polyductor 102 between the polymer granules and the water stream may allow dispersion of the polymer granules. Thus, use of polyductor 102, as described above, may result in faster hydration and minimize the require aging time for polymer activation.

In one embodiment, as dry flocculant polymer enters polyductor 102, a water regulation valve (not shown) may control the flow of water into polyductor 102. In polyductor 102, the water mixes with the dry flocculant polymer, and the resultant solution may be dispersed into an aging tank 103. In aging tank 103, the flocculant polymer may age in accordance with the time requirements of the flocculant being used. After proper aging, the flocculant may be injected into a line containing used drilling fluid via a flocculant solution pump 104 (e.g., a polymer solution pump, a positive displacement pump, or a diaphragm pump).

Still referring to FIG. 1, the injection of the flocculant into the used drilling fluid is controlled by a programmable logic controller (PLC) 105. PLC 105 may regulate the dispersion of the flocculant into used drilling fluids by controlling flocculant solution pump 104, a positive displacement pump (not shown), and/or a diaphragm pump (not shown). In alternate embodiments, PLC 105 may also control other processes in the system, such as, for example, the dispersion of flocculant from polyductor 102 into aging tank 103.

In other embodiments, specialized components may be used in system 100 to further increase dewatering efficiency. Referring briefly to FIG. 2, a modular dewatering system 200 including a three-stage aging tank 201 is shown. In this embodiment, aging tank 201 is divided into three sections, including, a mixing section 202, an aging section 203, and a pumping section 204. As flocculant solution enters mixing section 202 from a polyductor 205, an agitation device (not shown) may further mix the flocculant solution. After a proper mixing time, as determined by the properties of the flocculant used, the contents of mixing section 202 may be transferred to aging section 203. Those having ordinary skill in the art will appreciate that suitable agitation times are known in the art. In aging section 203, a second agitation device (not shown) may further mix and/or stir the solution until the solution has reached its desired properties. The solution may then be transferred into a pumping section 204, which may serve as a holding portion until the solution is pumped into a line containing used drilling fluid.

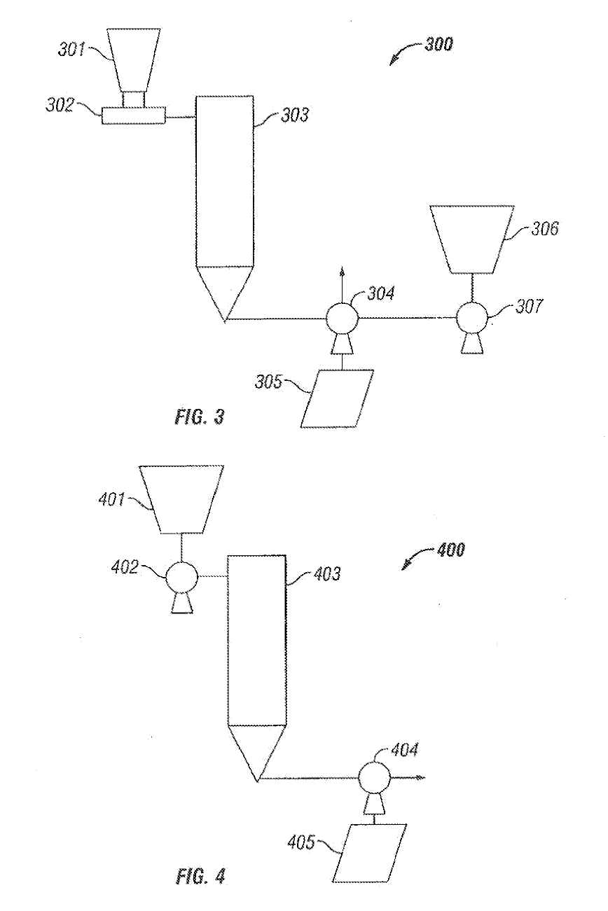

Referring now to FIG. 3, a modular dewatering system 300 in accordance with an embodiment of the present disclosure is shown. In this embodiment a dry flocculant feeder 301, a flocculant polyductor 302, a flocculant aging tank 303, and a solution pump 304 are connected, as described above. Additionally, a coagulant supply tank 306 may be connected to a water booster pump 307. Water booster pump 307 may allow the mixing of a liquid coagulant into a pressurized stream of water, thereby mixing a coagulant solution without the need of a separate aging/holding tank. In certain embodiments, water booster pump 307 may also be connected to a coagulant solution pump (not shown) for injection into a line containing used drilling fluid. As illustrated, solution pump 304 is configured to receive flocculant solution and coagulant solution and to inject the solutions into a line containing used drilling fluid.

In an alternate embodiment, as dry coagulant enters a polyductor, a water regulation valve may control the flow of water into the polyductor. In the polyductor, the water mixes with the dry coagulant polymer, and the resultant solution may be dispersed into an aging tank. In the aging tank, the coagulant may age in accordance with the time requirements of the coagulant being used. After proper aging, the coagulant may be injected into a line containing used drilling fluid via a water booster pump. One of ordinary skill in the art will realize that after mixing, certain coagulants may not require aging. In such a system, the aging tank may serve as a holding tank for mixed coagulant solution, or the coagulant solution may be directly injected from a line fluidly connecting the polyductor and a water booster pump, as described above.

Still referring to FIG. 3, the injection of the flocculant and coagulant into the used drilling fluid is controlled by a programmable logic controller (PLC) 305. Similarly as to system 100, PLC 305 may control the dispersion rate of flocculant solution into a line containing used drilling fluid. Additionally, PLC 305 may control the dispersion rate of coagulant solution into the line containing used drilling fluid. In certain embodiments, PLC 305 may control the dispersion rate of the flocculant and coagulants through appropriate pumping means, as described above. Additionally, PLC 305 may control other aspects of system 300, including but not limited to, control of polyductors 302 and 307 and aging times of aging tanks 303 and 308.

Referring now to FIG. 4, a liquid flocculant dewatering system 400 in accordance with an embodiment of the present disclosure, is shown. In this embodiment, a liquid flocculant supply tank 401 is connected to a dosing pump 402.

Supply tank 401 may include any device capable of holding a liquid flocculant. Dosing pump 402 is connected to supply tank 401 and may receive liquid flocculant solution therefrom. Dosing pump 402 injects liquid flocculant into an aging tank 403 for proper aging in accordance with the recommended aging for the flocculant. In certain embodiments, aging tank 403 may be substantially smaller than aging tanks of dry polymer systems because liquid flocculants require shorter aging times. After proper aging, liquid flocculant is injected into used drilling fluid via a flocculant solution pump 404.

In alternate embodiments, system 400 may further include a water booster pump (not shown). In such an embodiment, liquid flocculant is injected from supply tank 401 into a line between dosing pump 402 and aging tank 403. Water provided by a water booster pump (not shown) mixes with the liquid flocculant, and may then enter aging tank 403 for aging. The above process is described relative to liquid flocculant, but one of ordinary skill in the art will realize that dosing any substance (e.g., flocculant or coagulant) into a transfer line for mixing with water from a water booster pump is within the scope of the present disclosure. Furthermore, in certain embodiments, a water booster pump may provide water to any number of flocculant and/or coagulant transfer lines for dilution during transference.

Still referring to FIG. 4, the injection of the flocculant into the used drilling fluid is controlled by a PLC 405. In this embodiment, PLC 405 may regulate the dispersion of the flocculant into used drilling fluids by controlling water booster pump 405. In alternate embodiments, PLC 405 may also control other processes in the system, such as, for example, the dispersion of flocculant from dosing pump 402 into aging tank 403. PLC 405 may be used to control other aspects of the dewatering process, and will be described in greater detail below.

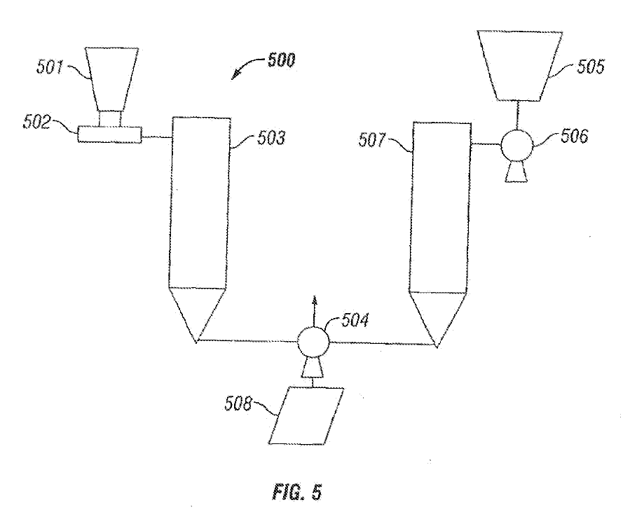

Referring now to FIG. 5, a combination dry flocculant and liquid flocculant dewatering system 500 in accordance with an embodiment of the present disclosure, is shown. In this embodiment, a dry flocculant feeder 501, a flocculant polyductor 502, and a flocculant aging tank 503, are connected to a flocculant solution pump 504, as described above. Additionally, a liquid supply tank 505, a liquid flocculant dosing pump 506, and a liquid flocculant aging tank 507 are connected to flocculant solution pump 504, as described above. One of ordinary skill in the art will realize that alternate systems may include any number of additional solution pumps such that flocculant may be efficiently injected. One embodiment may include a water booster pump (not shown) to dilute the liquid flocculant prior to aging in aging tank 507. The operation of system 500, including the operation of at least flocculant solution pump 504 may be controlled through a PLC 508, as described above. Moreover, in certain systems, a separation device (e.g., a centrifuge) may be fluidly connected to flocculant solution pump 504 to remove flocs from the used drilling fluid. One of ordinary skill in the art will realize that in certain embodiments, the separation device may be included on a portable skid.

In this embodiment, flocculant solution pump 504 is configured to receive feed lines from both flocculant aging tank 503 and liquid flocculant aging tank 507. Flocculant solution pump 504 may then inject flocculant into a line containing used drilling fluid. Typically, both dry flocculant and liquid flocculant will not be used in a single run. However, by giving a drilling operator the choice or using either type of flocculant in one system, the operator may choose the most effective flocculating technique. Additionally, because alternate systems may include multiple pumps, the present system may provide the drilling operator the ability to switch seamlessly between types of flocculants. Thus, in a drilling operation wherein the drilling operator runs out of, for example, a dry powder flocculant, the drilling operator may easily switch to a liquid flocculant. Such a seamless transition between flocculants may prevent downtime that could otherwise increase the overall cost of drilling.

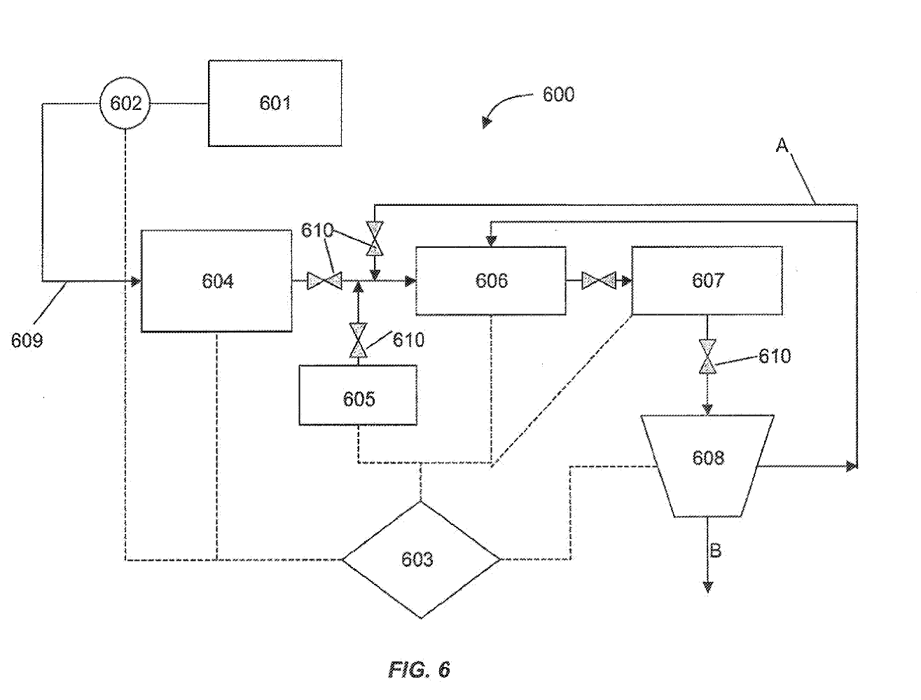

Referring to FIG. 6, a schematic representation of a dewatering system according to embodiments of the present disclosure is shown. In this embodiment, dewatering system 600 includes a drilling fluid inlet 601 (e.g., an inlet from an active drilling mud system) to allow a flow of drilling fluid to enter system 600. After the drill fluid enters inlet 601, one or more tests may be performed on the drilling fluid to determine properties of the drilling fluid. Examples of properties that may be determined include drilling fluid pH and flow rates, and inline sensor 602 may be used to determine one or more drilling fluid properties. To determine a pH of the drilling fluid in the fluid line, a pH sensor 602 may be used. The pH sensor 602 may include an inline real time sensor capable of returning a pH of the drilling fluid in real time or near real time to a PLC of system 600. Those of ordinary skill in the art will appreciate that the pH sensor 602 should be manufactured to be resistant to highly abrasive conditions, and capable of determining a drilling fluid pH at a plurality of flow rates. To determine a flow rate of the drilling fluid in the system, a flow rate sensor 602 may be used. In one embodiment, flow rate sensor 602 may include an inline sensor capable of determining flow rates of at up to 100 gallons per minute. However, in other embodiments, flow rate sensors capable of determining flow rates of greater than 100 gallons per minute may be preferable. Sensors used in accordance with the present disclosure may be tied into system controller 603 (e.g., a PLC), and may thus be used to provide real or near real time measurements of drilling fluid properties within dewatering system 600.

System controller 603 may include a number of components to allow for manual or automatic control of dewatering system 600. In one embodiment, system controller 603 includes an operator interface, such as a touch screen, that allows an operator to monitor and adjust system parameters. In other embodiments, system controller 603 may be configured to automatically adjust system parameters. Accordingly, system controller 603 may include input devices, such as peripherals and switches, and output devices, such as gauges and displays. System controller 603 may also include components for recording and storing data generated during the operation, such as hard drives and remote communications tools. The remote communication tools may include modems and/or satellite uplinks, thereby allowing system controller 603 to be monitor or controlled from a remote locations. In one embodiment, dewatering system 600 may be operated through a satellite uplink from a remote terminal, thereby allowing for one or more systems 600 to be monitored and controlled from a remote/centralized location.

In addition to receiving inputs from components of the system, system controller 603 may provide instructions through outputs to one or more components of the systems. Exemplary outputs may include instructions for acid, polymer, coagulant, and/or water injection, as well as include instructions to control pump rates, fluid flow rates, and system operation.

System controller 603 may be configured to receive inputs and provide outputs to one or more of the sub-systems of dewatering system 600. For example, in this embodiment, system controller 603 may provide instructions to acid system 604, effluent system 605, coagulant system 606, polymer system 607, and/or centrifuge 608. Additionally, system controller 603 may control other system components, such as a pump sub-system (not shown). The pump sub-system may include one or more pumps, such as progressive cavity pumps controlled by a variable frequency drive, to transfer drilling fluid from a tank connected to inlet 601 through sub-systems 604-607 to centrifuge 608. The pump sub-system may also include one or more sensors, such as drilling fluid flow sensors, motor speed proximity sensors, discharge sensors, and pump temperature sensors, such that the integrity and efficiency of the pump sub-system may be monitored. Additionally, system controller 603 may be configured to provide instructions to the pump sub-system to control the flow of drilling fluid through the system by, for example, modifying a flow rate. In certain embodiments, individual components of the pump sub-system may be operatively connected to system controller 603, such that system controller may modify instructions of a component individually. For example, system controller 603 may be connected to a pump to measure and control a flow rate. In other embodiments, system controller 603 may be connected to a pump sub-system controller (not shown), such that the system controller 603 provides instructions to a control module of the sub-system.

System controller 603 is also operatively connected to sub-systems 604-608 so as to control the operation of the individual sub-systems, or to otherwise record information from the sub-systems. While one or more of sub-systems 604-608 provide data to system controller, thereby allowing system controller 603 to optimize the efficiency of dewatering system 600, system controller 603 may also include a manual override, thereby allowing an operator to modify the instructions provided to each of the sub-systems. Acid system 604, effluent system 605, coagulant system 606, polymer system 607, and centrifuge 608 will be discussed in detail below.

Examples of electronic sensors that may be tied into system controller 603 includes magnetic flow sensors disposed in flow line 609, pH sensors in flow line 609, and RPM proximity sensors on a mud pump providing fluid flow to dewatering system 600. Additionally, system controller 603 may receive input from RPM proximity sensors of acid system 604, coagulant system 606, and polymer system 607. Furthermore, system controller 603 may receive input from one or more sensors, such as coagulant tank sensors, effluent tank sensors, water booster pump sensors, polymer injection sensors, polymer tank sensors, feeder sensors (e.g., sensors of a polymer mixing system), water pressure switches, and temperature sensors. In response to the inputs, system controller 603 may control one or more outputs, such as alarm lights, aural alarm signals, digital interface controls, as well as controls for components of acid system 604, effluent system 605, coagulant system 606, and/or polymer system 607.

Acid system 604 allows acid to be transferred from a tank to flow line 609. Thus, acid system 604 may allow for a precise amount of acid to be added to drilling fluid within dewatering system 600 to control the pH of the fluid. Acid system 604 may include an acid injection pump and one or more sensors. Acid injection pumps may include a peristaltic or diaphragm pump capable of providing, for example, 60 gallons per day of acid to system 600. The acid pump may be connected to an acid storage tank, which may be part of acid system 604 or may be pumped from another location at the drill site. Acid system may also include one or more sensors, such as pH sensors and injection sensors to monitor acid dosage rates. The sensors may be connected to system controller 603, thereby allowing for the monitoring of pH and injection rates of acid into the system. Furthermore, those of ordinary skill in the art will appreciate that in certain embodiments, acid system 604 may be used to increase the pH of the fluid using alkaline sources. Thus, acid system 604 may be used to increase, decrease, or otherwise regulate the pH of fluids in the system.

In alternative embodiments, the sensors may provide data to an acid system controller (not shown), which then provides data to system controller 603 including the pH of the drilling fluid and/or a dosage rate of acid. In other embodiments, system controller 603 may provide instructions to acid system 604 to vary an acid addition rate based on a pH reading from one or more of the sensors of system 600. In still other embodiments, acid system 604 may include alarms capable of alerting an operator if an acid leak is detected, or if the volume of acid in the storage tank drops below a specified level. Acid system 604 may also include input/output capability to system controller 603 to allow for leakage detection, pump rates, pH measurements, and/or pump revolutions per minute (“RPM”) to be recorded, displayed for an operator, or used to modify system instructions in an automated system.

Effluent system 605 provides dilution resources to flow line 609 as well as to coagulant system 606. Thus, effluent system 605 allows for dilution of fluids in flow line 609, as well as for the dilution of coagulants in coagulant system 606. In still further embodiments, effluent system 605 may be used to clean components of dewatering system 600 by running water and/or other fluids therethrough. In this embodiment, effluent system 605 includes a effluent tank (not shown) with a plurality of switches to alert an operator of a fluid level within the tank. Additionally, the system includes a pump, such as a centrifugal pump configured to provide a flow of water from the effluent tanks to dewatering system 600, as well as a plurality of motors and valves for controlling the flow of water therein.

During operation of dewatering system 600, inputs and/or outputs from effluent system 605 may supply data to system controller 603. Examples of input and outputs that may be transmitted therebetween include tank levels (e.g., high and low levels), motor starter signals, pump rates, valve controls (e.g., to allow for the control of solenoid valves), and control parameters for other aspects of effluent system 605. Additionally, system controller 603 may receive inputs or provide outputs to and/or from effluent system 605 such that an alarm is sounded to an operator. Examples of alarms may include tank level alarms. In one embodiment, if a tank level falls below a required level, the system controller 603 may be alerted, an alarm may be activated, thereby informing the operator of the low tank level condition. In certain embodiments, system controller 603 may then automatically turn off the pump, such that the system is not damaged, or other components may be adjusted to account for the lack of effluent in the system.

In certain embodiments, effluent system 605 may also include a water pump booster system (not shown). The water pump booster system may be used to provide a specified pressure in the water lines of dewatering system 600. Examples of components that may be used in the water pump booster system include one or more pumps, such as centrifugal pumps, a plurality of motors, and a series of flow switches to control the flow of water and pressure in the system. The water pump booster system may also be operatively connected to system controller 603, such that system controller 603 may control the operation of components of the water pump booster system. In certain embodiments, system controller 603 may be configured to control the control of pressure via controlling the actuation of pumps, motors, and switches of the water pump booster system. Those of ordinary skill in the art will appreciate that the water pump booster system may be required, in certain embodiments, to provide a desired pressure to the dewatering system 600, however, in alternate embodiments, water pump booster system may not be necessary. Additionally, a water pump booster system may be a system discrete from effluent system 605, and as such, may have independent controls and/or connections to system controller 603. In such an embodiment, water pump booster system may be connected to the rig water supply or the effluent system to supply fluids to aspects of dewatering system 600.

Coagulant system 606 uses one or more pumps to meter a coagulant and a dilution source into dewatering system 600. Thus, coagulant system 606 may include one or more pumps, such as peristaltic or diaphragm pumps capable of pumping, for example 180 gallons per day, revolution per minute sensors, a plurality of valves (e.g., solenoid valves), and a coagulant tank having one or more sensors disposed therein. In other embodiments, varied pumps may alternatively be used to pump a less or greater volume of coagulant and/or fluids in the system. Coagulant system 606 is also operatively connected to system controller 603, such that a series of inputs and outputs may be transmitted therebetween.

In operation, an operator may select a dosage rate of coagulant, and then system controller 603 may provide instructions to a pump of coagulant system 606 to inject the desired quantity of coagulant into dewatering system 600. The dosage pump rate may be based on both the dosage rate of the coagulant and the flow rate of fluids within the system. If dilution is needed, water may be added to coagulant system by, for example, opening a solenoid valve controlling the flow of water from either effluent system 605 or the water booster pump system. Thus, coagulant system 606 may include instructions to control the rate of addition of a coagulant into flow line 609. Additionally, system controller 603 may provide or receive a plurality of inputs and outputs to and from coagulant system 606. Examples of inputs and outputs may include leakage detection sensors, pump revolutions per minute sensors, tank level sensors, solenoid controls, and pump controls.

Polymer system 607 provides for a metered injection of premixed polymers from the system into flow line 609. Polymer system 607 may thus include an injection pump, such as a progressive cavity injection pump, one or more motors and/or variable frequency drives, a polymer tank having one or more level switches, and one or more pump sensors, such as revolution per minute sensors.

In operation, an operator may enter a desired polymer concentration or a dosage ratio into system controller 603. System controller 603 may then provide instructions to polymer system 607 to actuate a pump to modulate the injection rate of the polymer into flow line 609 such that the desired polymer dosage is achieved based on a determined instantaneous fluid flow rate through flow line 609. Thus, as flow rate of fluids through flow line 609 changes, the dosage rate of polymer may be modulated, such that the concentration of polymer within the system remains at a desired level or within a desired range. Those of ordinary skill in the art will appreciate that the specific polymer level and/or the preferred range may vary depending on the specifics of the dewatering operation. Additionally, system controller 603 may interface with polymer system 607 to allow for the input and/or output of variables such as tank levels, injection flow rates, pump revolutions per minute, pump controls, variable frequency controls, and/or valve controls.

Polymer system 607 may also include a polymer mixing system (not shown). A polymer mixing system may be used to mix dry polymer such that a proper hydration of the polymer is achieve at a desired concentration. Polymer mixing systems may include those as described above, and may also include other components. Examples of components of a polymer mixing may include a polymer feeder, one or more switches to allow for the addition of water either from the rig or effluent system 605, one or more pumps, mixing tanks having agitators, heaters, and temperature probes and/or other sensors.

During operation, in order to mix polymer for injection, polymer mixing system may request rig water or water from effluent system 605, actuate the agitators, and add a selected quantity of polymer to a mixing tank. After the polymer is mixed, it may be pumped to an aging tank, wherein additional agitators may be actuated. During both mixing and aging of the polymer, the temperature and/or other parameters of the mixed polymer may be determined and regulated through heaters. After the polymer is mixed and aged according to the specifications of the particular polymer, the mixed and aged polymer may be transferred to polymer system 607. System controller 603 may be used to control polymer system 607 and/or the polymer mixing system, and as such, may be used to control the concentration of the mixed polymer, the aging of the polymer, and the transfer of the polymer between polymer system 607 and polymer mixing system.

Dewatering system 600 may also include a mud pump system configured to provide a flow of fluid through flow line 609 from inlet 601 to centrifuge 608. An exemplary mud pump system may include a centrifugal or progressive cavity pump controlled by a variable frequency drive. In certain embodiments, the mud pump system may further include pumps capable of providing 100 gallon per minute of fluid from a tank (not part of the system) to an elevated centrifuge. During the flow of fluid between the tank and the centrifuge through flow line 609, the fluid may be treated in one or more of acid system 604, coagulant system 606, and/or polymer system 607. Accordingly, system controller 603 may control the mud pump system either directly or indirectly.

Dewatering system 600 may also include one or more valves 610 to control the flow of fluid through fluid line 609. Valves 610 may be in addition to the individual valves of sub-systems 604-607. An operator may manually control valves 610, or in certain embodiments, valves 610 may be controlled through system controller 603.

As fluid flows through dewatering system 600, the fluid is treated by sub-systems 604-607. After treatment, the fluid is provided to a separation device, such as a centrifuge 608. In certain embodiments, the control of centrifuge 608 may be through system controller 603, however, those of ordinary skill in the art will appreciate that centrifuge may be a component of a dewatering operation separate from system 600. As such, in certain embodiments, centrifuge 608 may not be controlled directly through system controller 603. However, in embodiments including a centrifuge control, system controller 603 may be used to control the speed of centrifuge 608, the rate of fluid flow into centrifuge 608, as well as monitor the separated solid phase and fluid phase volumes.

Moreover, as centrifuge 608 separates solid phase from fluid phase, part of the fluid phase may be returned to dewatering system 600, as illustrated by flow path A. Additionally, fluid phase may be transferred back into the active drilling system, as illustrated by flow path B. Those of ordinary skill in the art will appreciate that by recycling part of the fluid phase back into dewatering system 600, the fluid may be further treated, so as to further clean the fluid.

In certain embodiments, dewatering system 600 may be housed within a single structure or on a single skid, thereby allowing the system 600 to be transportable and substantially self-contained. In such an embodiment, dewatering system 600 may be transported to a rig location and provided with an input line from a tank containing drilling fluid. The input line may be attached to system 600 to allow a flow of drilling fluid from the storage tank, the drilling fluid may be processed, and an output line may be connected between dewatering system 600 and a separation device, such as separator 608. Such an embodiment would provide a substantially self-contained dewatering unit that is transportable to both land and water drilling locations. For example, in one embodiment, the above described components may be enclosed within a shipping container, such as a 20′×8′×9′ ISO container or a 30′×8′×9′ ISO container. The size of the container used may depend, for example, on the type of application the system is being used in. For example, in a land-based application, the container size may be less important than in a rig-based application, where space may be at a premium, so a smaller container may be preferred. Such an embodiment may include both the above-described sub-systems, as well as a fluids lab and office area to allow an operator to monitor the system. In addition to allowing for ease of transportation, the system 600 may be substantially plug-and-play, thereby providing all of the equipment required to dewater water-based drilling fluid. Such systems may further include connectivity optimized for interconnection with typical rig site electrical and water services, and may include additional components such as centrifuge feed pumps and auxiliary power supplies.

In still other embodiments, embodiments disclosed herein may provide for a centralized fluid-processing center. For example, dewatering system 600 may be transported and set-up at a centralized location near more than one drilling location or well site. As drilling fluid is produced by the one or more drilling operations, all of the fluid may be transported to dewatering system 600 for centralized processing. Thus, dewatering system 600 may processing drilling fluid from multiple drilling locations.

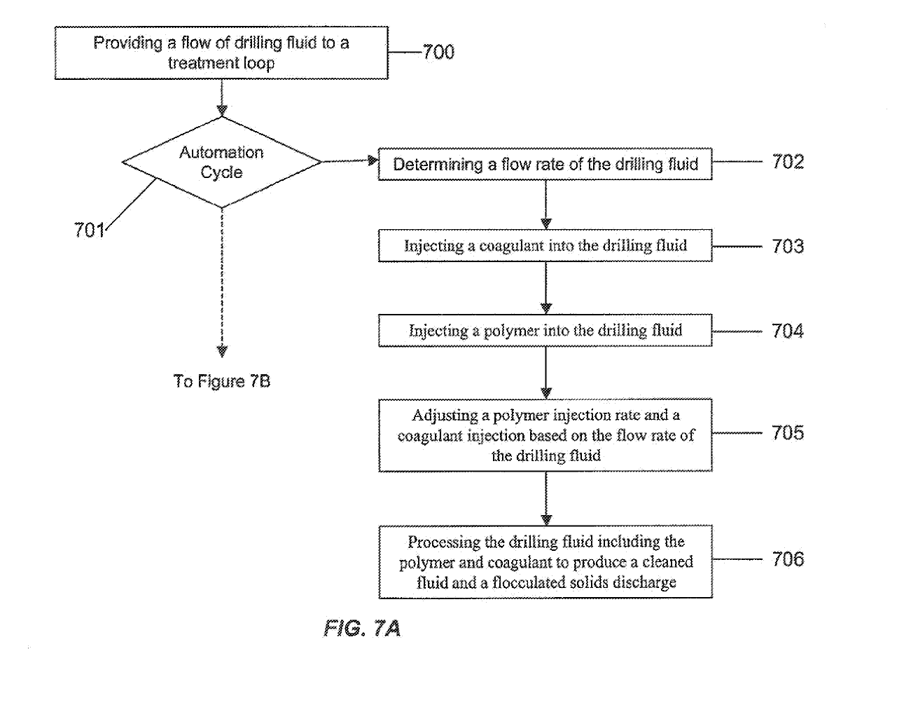

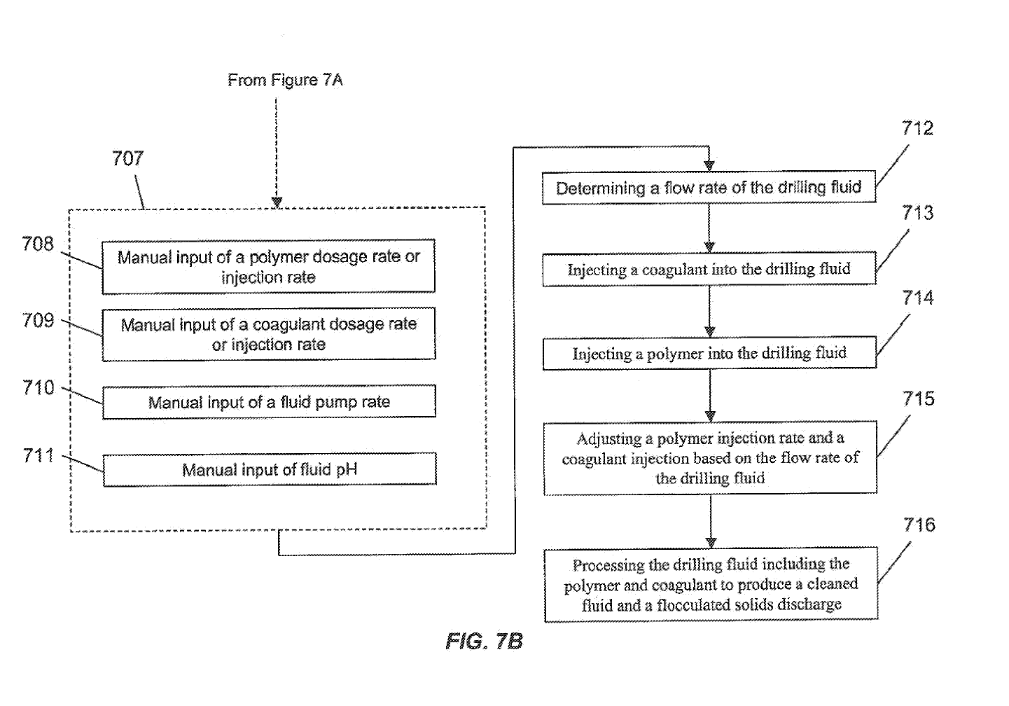

Referring now to FIGS. 7A and 7B, a flow chart of an automation cycle and manual override cycle according to embodiments of the present disclosure is shown. In this embodiment, a flow of drilling fluid is provided to a treatment loop of a dewatering system (700). The flow may be provided according to any of the methods described above, for example, in one embodiment, a mud pump may provide a flow of drilling fluid from a storage tank to an inlet of the dewatering system. An operator then determines whether to override the automatic dewatering cycle by providing manual inputs (701). Those of ordinary skill in the art will appreciate that when starting a dewatering operation for the first time, or during subsequent intervals of processing, it may be beneficial to provide the dewatering system initial inputs, such as, for example, the type of polymer being used, the type of coagulant being used, an average expected flow rate, a desired pH, a desired flow rate, the type of formation being drilled, and a desired dosage rate of polymer and/or coagulant.

If the operator allows the dewatering system to be automated, a flow rate of drilling fluid in the system is determined (702). This determination may include the collection of data from a mud pump sensor or flow line sensor by a system controller and/or an instantaneous flow rate determined by a sub-system of the dewatering system, such as by acid system, coagulant system, and/or polymer system. In addition to determining a flow rate of the drilling fluid, additional drilling fluid properties may be determined. Examples of additional drilling fluid properties that may be determined include pH, viscosity, and temperature. For example, in certain embodiments, a pH sensor may allow for a pH of the drilling fluid to be determined, such that a pH modifier, such as an acid, may be injected into the system to provide a desired pH of the drilling fluid.

After the flow rate of the drilling fluid in the system is determined (702), a coagulant is injected into the drilling fluid based on the flow rate of the drilling fluid (703). In the automation cycle, the volume of coagulant injection may be based on previously input data supplied by an operator, or may alternatively include an adjustment to the coagulant volume based on other calculated drilling fluid parameters, such as a viscosity, temperature, or pH of the drilling fluid. In addition to the injection of coagulant, the drilling fluid may be diluted with an effluent, such as rig water, or an effluent from the effluent system, as described above. In such an embodiment, the injection of an effluent may occur prior to injection of the coagulant into the drilling fluid, or contemporaneous with coagulant injection.

After injection of the coagulant (703) a polymer may be injected into the drilling fluid (704). The injected polymer may include any of the polymers discussed above, and as such, may include both liquid polymers and dry polymers previously mixed in a polymer mixing system, as discussed above. Polymer injection may occur as an inline injection directly into the flow line carrying the drilling fluid, or in alternative embodiments, the drilling fluid may be portioned into a holding tank wherein a polymer is injected, and then the drilling fluid with the polymer may be transported back into the flow line.

As the drilling fluid continues to flow through the dewatering system, the automation cycle (701) may continuously monitor the drilling fluid flow rate, and the coagulant and polymer injection rates may be adjusted based on changing drilling fluid flow rates. The monitoring of the drilling fluid flow rates may occur by determining instantaneous flow rates at specific points along the flow line, such as points of entry of the drilling fluid into the coagulant injection sub-system or the polymer injection sub-system. Thus, the volume of coagulant and polymer injection may continuously be adjusted based on changing drilling fluid flow rates. Furthermore, sensors along the flow line may monitor one or more other drilling parameters or sub-systems, such as a pH, or water system, and adjust the volumes of coagulant and/or polymer based on the other drilling parameters.

As the coagulant and polymer injection rates are adjusted, the drilling fluid continues to flow through the dewatering system. Accordingly, the drilling fluid is processed to produces a cleaned fluid and a flocculated solids discharge (706). The solids discharge may then be routed to a disposal location, while the cleaned fluid is either directed back to the active mud system or used in other aspects of the drilling operation, such as an effluent in the dewatering system.

Referring back to the selection of an automation cycle (701), if an operator overrides the automation system and in lieu of a manual cycle (707), then the operator will select the parameters for the dewatering operation. Examples of manual parameters that an operator may adjusted include the input of a polymer dosage rate or injection rate (708), manual input of a coagulant dosage rate or injection rate (709), manual input of a fluid pump rate (710), or a fluid pH (711). The selection of the manual inputs may occur based on operator knowledge, or may merely be initial inputs to establish a baseline for fluid processing, such that an automation cycle (701) may adjust the values of the inputs during subsequent processing. Additionally, the inputs may include ranges, such that an operator defines a range of a polymer dosage rate that an automation cycle may select between. Thus, the manual input may include both overriding the automation cycle (701), or may provide inputs used by the automation cycle (701) in determining a preferable dewatering condition.

After the operator selects input values for the desired parameters, the system may determine a flow rate of drilling fluid within the system (712), inject a coagulant based on the manual input values (713) and inject a polymer based on the manual input values (714). Similar to the automation cycle (701), an operator may subsequently adjust coagulant and/or polymer injection rates based on changing flow rates (715), and provide for the processing of the drilling fluid to produce a cleaned fluid and a flocculated solids discharge (716).

The ability of the dewatering system to process drilling fluids and adjust coagulant and polymer injection automatically may provide for a more efficient processing of drilling fluids. For example, as the formation being drilled changes, the volume of coagulant and polymer injected into the drilling fluid may require adjustment. Because the system may include inputs such as the formation type being drilled, as well as the ability to automatically monitor and determine changes in flow rates, pH, and other drilling fluid parameters, the system may automatically adjust the injection rates of polymers and coagulants to adapt to formation changes. Those of ordinary skill in the art will appreciate that failure to adjust coagulant and polymer injection rates based on changes to the drilling fluid, which occur during drilling, may result in dewatering operations that produce fluids that may cause damage to the well. For example, not providing sufficient flocculation to remove drilled solids from the fluid may result in a return of drilled solids to the active mud system that result in drilled solids being pumped back downhole. By pumping drilled solids back downhole, the wellbore may be damaged, and similarly, downhole tools, such as drill bits and monitoring devices may be prone to premature failure. Similarly, by over-treating the drilling fluid, residual coagulant and polymers may be transmitted to the active mud system, thereby causing flocculation of drilled solids within the well. The flocculation of drilled solids within the well may thus result in well failure.

Similarly, the automation cycle (701) of the present disclosure may provide for a dewatering system that can adapt to formation changes, as well as changes to drilling fluid parameters and fluid flow rates more quickly than manual dewatering systems. The sensors that provide data to the system controller may thus allow the dewatering system to automatically adjust injection rates, as well as the chemistries of the polymers and coagulants. Accordingly, a faster response time to changes in drilling conditions and fluid parameters may result in more efficient dewatering, as well as less likely failure of the wellbore due to under-treating or over-treating the drilling fluid. Additionally, the user may have access to a user interface thereby allowing the operator to monitor the activity of the dewatering system, such that an override may be initiated if desired.

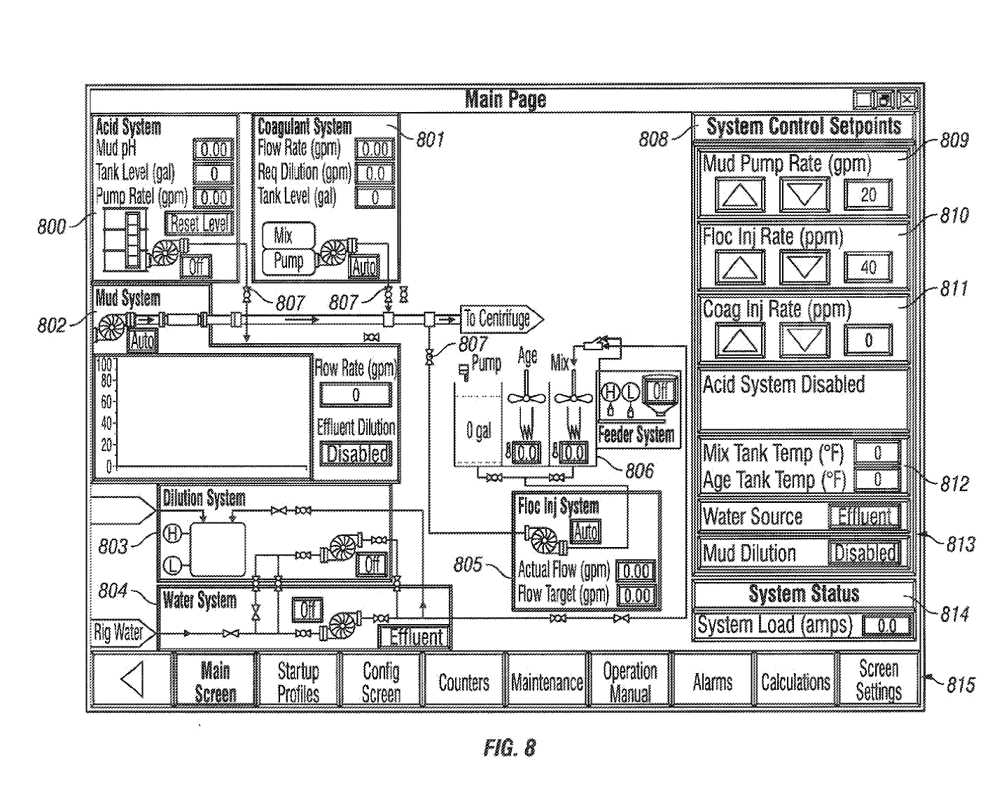

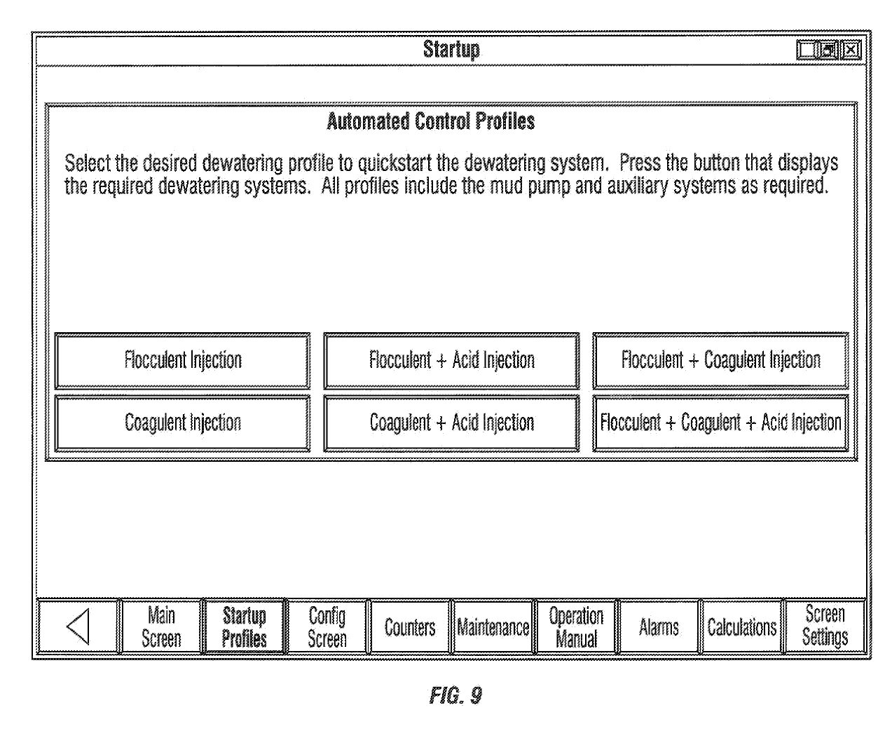

Referring to FIGS. 8-11, screen shots of a user interface according to embodiments of the present disclosure are shown. The user interfaces disclosed herein may allow an operator to input specific values for operations of the dewatering system, as well as allow a drilling operator to monitor the activities of the dewatering system during operation.

Referring first to FIG. 8, a main page showing an overview of the dewatering system according to embodiments of the present disclosure is shown. The main page has individual monitoring components for each of the sub-systems of the dewatering system, such as an overview of acid system 800, coagulant system 801, mud flow system 802, dilution system 803, water system 804, polymer system 805, and polymer mixing system 806.

The display of individual sub-systems may thereby allow a drilling operator to monitor the actions of components of the sub-systems. For example, acid system 800 includes a display of mud pH, tank level, and pump rate. Thus, a drilling operator may evaluate the condition and the operation of critical components of acid system 800. Similarly, coagulant system 801 includes a display of flow rate, required dilution, and tank level. Mud system 802 includes a graphical display of the flow of drilling fluid within the system, as well as the valves 807 providing the flow of material into the flow line. Additionally, mud system 802 displays graphically representations of the flow rate of drilling fluid, and allows for the monitoring of effluent dilution. Those of ordinary skill in the art will appreciate that in other embodiments, alternative graphical representations may be included, such as visual alerts, other drilling fluid parameters, and displays of other system components. In other aspects, the graphical user interface may also include additional options and/or displays, such as a desired target flow of coagulant or acid rates. These options may be adjusted or monitored by a drilling operator to further optimize the process.

The user interface also includes a system control setpoints control box 808, configured to allow an operator to monitor and manually adjust system parameters such as mud pump rate 809, polymer injection rate, 809, and coagulant injection rate 810. The system control setpoints control box 808 may thus allow for an operator to manually override the automatic adjustment of system parameters to a desired value. Additionally, the user interface includes the graphical display of temperatures of the mixing tanks and aging tanks 812, control boxes to allow for the enablement/disablement of system components (such as water source and mud dilution) 813, and a system status 814 box that displays the system load.

The user interface also includes a series of tabs 815 to allow an operator to view other aspects of the interface, such as tabs for startup profiles, configurations screens, counters, maintenance, operation manuals, alarms, calculations, and screen settings. Upon selection of a tab, the user interface may pull up additional graphical representations of the desired information.

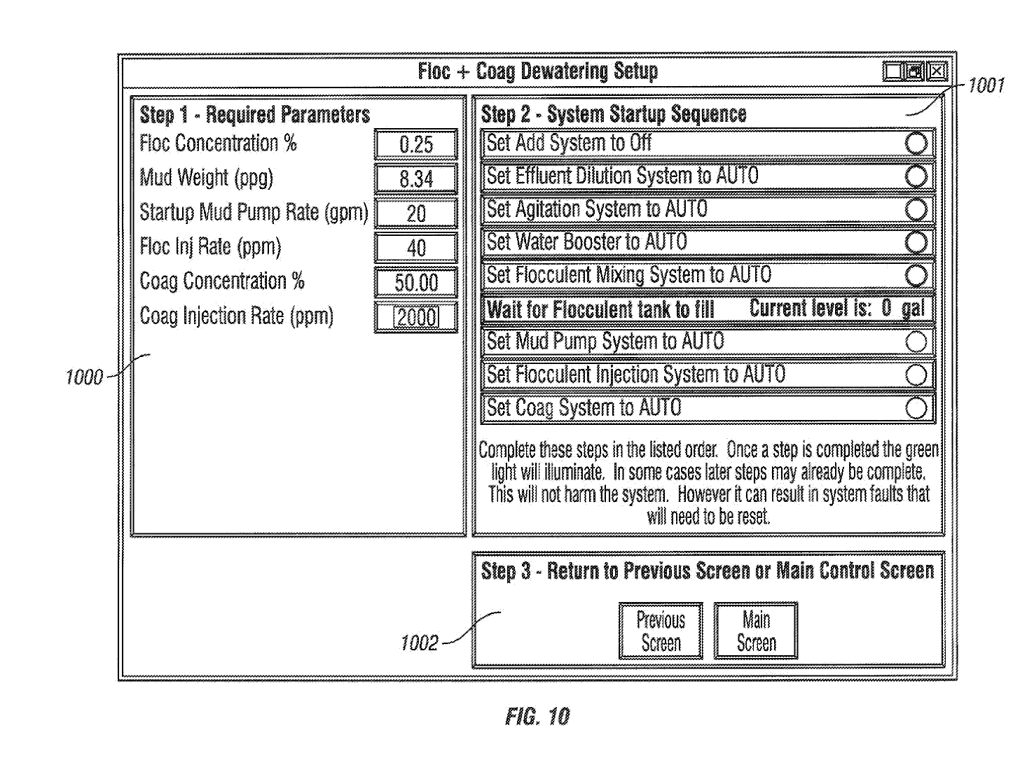

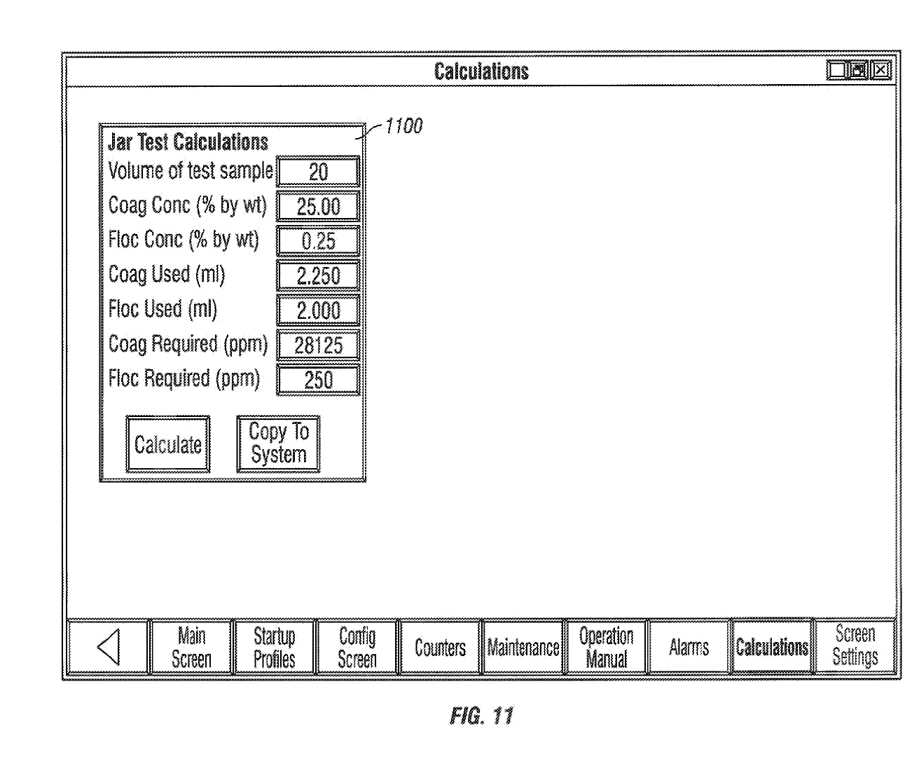

Referring to FIG. 9, a startup screen showing startup profiles for the dewatering system according to embodiments of the present disclosure is shown. Selection of the startup profiles screen allows an operator to view the automated control profiles, such as flocculant injection; flocculant and acid injection; flocculant and coagulant injection; coagulant injection; coagulant and acid injection, and flocculant, coagulant, and acid injection. To illustrate the automated control profiles, the flocculant and coagulant dewatering startup profile is selected in FIG. 10.

The startup profile allows a drilling operator to select required parameters 1000, such as flocculant concentration, mud weight, startup mud pump rate, flocculant injection rate, coagulant concentration, and coagulant injection rate. Additionally, in certain embodiments, the operator may be able to select a range of parameters for automated selection by the system controller. In addition to allowing for required parameters to be defined, a system startup sequence 1001 may be selected. The system startup sequence 1001 allows a drilling operator to select the operation condition of the sub-systems. For example, a drilling operator may select when sub-systems are in an on condition, an off condition, or an automated condition. The conditions may also be represented as colored indicators (e.g., red for off green for on, and yellow for automated), such that an operator may view the condition of individual sub-systems. Finally, the startup profile may allow an operator to navigate between various screens through a navigation control box 1002.

Referring to FIG. 11, a calculations screen showing startup profiles for the dewatering system according to embodiments of the present disclosure is shown. The calculations screen includes an input control box 1100 to allow a drilling operator to input values determined by an on-site mud lab. Because embodiments disclosed herein may include an on-site mud lab, the calculations screen allows a drilling operator the ability to test the drilling fluid, and subsequently input the results of the mud test for use by system controller. In alternative embodiments, the calculation screen may allow a drilling operator to calculate a suggested coagulant and flocculant volume according to specified test parameters. Thus, calculations may provide an operator both information regarding recommended coagulant and polymer volumes, as well as allow an operator to input values of a mud test, such that the automated system may control the injection of coagulant and polymers accordingly.

Advantageously, embodiments of the present disclosure may allow for a more efficient processing of drilling fluids at a drilling location. Because embodiments disclosed herein may allow for the substantially automated adjustment of dewatering system parameters, thereby allowing for the continuous adjustment of coagulant and polymer injection rates, the coagulant and polymer injection may be optimized. By optimizing the coagulant and polymer injection, dewatering systems described herein may avoid under-treating or over-treating a well, both of which may result in losing the well.

Also advantageously, embodiments of the present disclosure may allow for a system controller, thereby allowing the dewatering system to be controlled from a centralized location. Because a single system controller may control multiple sub-systems, multiple aspects of the operation, such as pH adjustment, coagulant injection, and polymer injection may all be optimized relative to one another. Thus, as one aspect of a sub-system requires adjustment, the system controller may modify aspects of other sub-systems to provide for an optimized dewatering system.

Furthermore, embodiments of the present disclosure may allow for a centralized processing operation, thereby allowing drilling fluid from multiple drilling locations to be treated by a centralized dewatering unit. Because multiple wells may be treated with a single unit, dewatering may be more cost efficient, and produce a higher return of cleaned fluid. Additionally, because dewatering systems disclosed herein may be transportable, hook up and take down time associated with setting up and removing dewatering components from a drilling location may be decreased, further decreasing the cost of dewatering drilling fluids.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A method of cleaning drilling fluid, the method comprising:
providing a flow of drilling fluid to a treatment loop;
determining a flow rate of the drilling fluid;
injecting a polymer into the drilling fluid based on the determined flow rate of the drilling fluid;
injecting a coagulant into the drilling fluid based on the determined flow rate of the drilling fluid, and
adjusting the rate of polymer and coagulant injection based on a change in the flow rate of the drilling fluid.

2. The method of claim 1, further comprising:
diluting the drilling fluid with an effluent.

3. The method of claim 2, wherein the effluent comprises the cleaned fluid.

4. The method of claim 1, further comprising:
determining a pH of the drilling fluid.

5. The method of claim 4, further comprising:
injecting a pH modifier based on the determined pH of the drilling fluid.

6. The method of claim 1, further comprising:
mixing the cleaned fluid with the coagulant prior to injecting the coagulant into the drilling fluid.

7. The method of claim 1, further comprising:
processing the drilling fluid including the polymer and coagulant to produce a cleaned fluid and a flocculated solids discharge.

8. The method of claim 7, wherein the processing comprises transferring the drilling fluid to a centrifuge.

9. The method of claim 1, further comprising:
monitoring continuously the flow rate of the drilling fluid in the treatment loop; and
adjusting the rate of polymer and coagulant injection based on the monitored flow rate.

10. A method of controlling a drilling fluid cleaning system, the method comprising:
inputting a polymer dosage rate and a coagulant dosage rate into a system controller; and
providing instructions to the system controller for:
determining an instantaneous flow rate of a drilling fluid in the system;
calculating a polymer injection rate to produce the inputted polymer dosage rate based on the instantaneous flow rate of the drilling fluid;
calculating a coagulant injection rate to produce the inputted coagulant dosage rate based on the instantaneous flow rate of the drilling fluid; and
adjusting the polymer injection rate and the coagulant injection rate based on the instantaneous flow rate.

11. The method of claim 10, wherein the adjusting further comprises instructions for:
actuating a polymer injection pump.

12. The method of claim 10, wherein the adjusting further comprises instructions for:
actuating a coagulant injection pump.

13. The method of claim 10, wherein the instructions comprise automation instructions for continuously monitoring the flow rate of the drilling fluid.

14. The method of claim 13, wherein the automation instructions further comprise instructions for adjusting the polymer injection rate and the coagulant injection rate based on the continuously monitored flow rate of the drilling fluid.

15. The method of claim 10, further comprising:
outputting at least one of the determined instantaneous flow rate, the polymer injection rate, and the coagulant injection rate.

16. The method of claim 15, wherein the outputting comprises at least one of generating a graphical representation, generating a print report, and transferring to a remote location.

17. The method of claim 10, wherein the instructions are provided at least in part remotely.

18. A system for processing drilling fluid, the system comprising:
an acid sub-system configured to modify the pH of the drilling fluid;
a coagulant sub-system configured to inject a coagulant to the drilling fluid;
a polymer sub-system configured to inject a polymer to the drilling fluid; and
a system controller configured to automatically adjust the coagulant and polymer injection into the drilling fluid.

19. The system of claim 18, wherein the system controller comprises a programmable logic controller.

20. The system of claim 18, wherein the system controller is configured to determine an instantaneous flow rate of drilling fluid in the system.
